(19) United States
(12) Patent Application Publication
(10) Pub. No.: US 2015/0331634 A1
(43) Pub. Date: Nov. 19, 2015

(54) CONTINUOUS-FLOW CONFLICT-FREE MIXED-RADIX FAST FOURIER TRANSFORM IN MULTI-BANK MEMORY

(71) Applicant: Sergei I. SALISHCHEV, Sankt-Petersburg (RU)

(72) Inventor: Sergei I. SALISHCHEV, Sankt-Petersburg (RU)

(21) Appl. No.: 13/878,672

(22) PCT Filed: Jan. 9, 2013
(86) PCT No.: PCT/RU2013/000001

§ 371 Date: Aug. 5, 2013

(51) Int. Cl. G06F 3/06

(52) U.S. Cl. CPC G06F 3/0646; G06F 3/0613; G06F 3/0673

(57) ABSTRACT

A method and a processor to perform continuous-flow conflict-free mixed-radix FFT for data in a memory are provided. Multiple butterfly calculations of small radix are launched generally in parallel in mixed-radix FFT using conflict-free address generation with a memory. The multiple butterfly calculations of data entries may be staged in a processor, such that the memory read and write operations may be executed continuously without access conflicts.

### CROSS REFERENCE TO RELATED APPLICATIONS

This is a 371 national phase application of PCT/RU2013/000001 filed on Jan. 9, 2013, the entire contents of which are incorporated herein by reference.

### FIELD OF THE INVENTION

The present disclosure relates to continuous-flow conflict-free mixed-radix fast Fourier transform (FFT) in multi-bank memory, and in particular to methods of performing FFT by launching multiple butterfly stage operations simultaneously using multiple memory banks to maximize use of memory space during mixed-radix FFT, in order to reduce circuit space, clock, and power requirements.

### DESCRIPTION OF RELATED ART

Digital signal processing tasks may be performed by a Digital Signal Processor (DSP) in various types of applications, such as communications, video and audio processing, financial analysis, biological data analysis, and environmental sciences. A DSP may be a specialized microprocessor. FFT operations may be used to process signals in time or frequency domains in such applications. FFT operations may include Decimation in Time (DIT) and Decimation in Frequency (DIF) decomposition operations.

FFT operations may be performed on data entries stored in a memory. The DSP may perform multiple stages of multiply-accumulate operations and data transposition operations on the data entries. These stages are sometimes called “butterflies”. Each butterfly may have a base-size (radix). For example, a FFT using butterflies of base-2 may be a radix-2 FFT. A FFT having butterflies of two different base sizes may be called “mixed radix” FFT.

FFT operations may be implemented on a software level in the DSP, or using specialized hardware architecture in the DSP. Performance of the DSP in the various applications depends on the performance of the FFT operations, which may depend on various factors. For example, data processed through the FFT operations may typically be stored in memory during processing. Thus, the memory space required and the timing of memory read and write operations may impact the overall performance and cost of the DSP.

Thus, there is a continual need to perform FFT operations with minimal hardware space, power, and timing requirements, and the fastest data processing speed.

### DESCRIPTION OF THE FIGURES

Embodiments are illustrated by way of example and not limitation in the Figures of the accompanying drawings:

FIG. 1 illustrates an exemplary method of processing data according to an embodiment of the present disclosure.

FIG. 2 illustrates an exemplary processing device according to an embodiment of the present disclosure.

FIG. 3 illustrates an exemplary processing device according to an embodiment of the present disclosure.

FIG. 4 illustrates an exemplary processing device according to an embodiment of the present disclosure.

FIG. 5 illustrates an exemplary processing device according to an embodiment of the present disclosure.

FIG. 6 illustrates an exemplary processing device according to an embodiment of the present disclosure.

### DETAILED DESCRIPTION

According to various embodiments of the present disclosure, a method and a processor to perform continuous-flow conflict-free mixed-radix FFT for data in a memory are provided. Multiple butterfly calculations of small radix are launched generally in parallel in mixed-radix FFT using conflict-free address generation with a memory. The multiple butterfly calculations of data entries may be staged in a processor, such that the memory read and write operations may be executed continuously without access conflicts.

In this configuration, the mixed-radix FFT operation may be carried out with maximum memory data through-put, minimum wait time, and less costs in memory circuit space and power.

A dual-port memory architecture may be used. Alternatively, a single-port memory architecture may be provided with an in-place strategy, further reducing port routing circuit space requirement.

Self-sorting architecture using overlapped operations for data I/O with natural order FFT may increase FFT performance.

A common approach to FFT processor architecture may be an “in-place” memory-based FFT. Use of this approach guarantees that for each butterfly or group of butterflies both inputs and results are stored in the same memory locations. For example, a FFT of data points sampled at N points may use a memory with N complex words capacity.

One butterfly calculation may be initiated every clock to maximize memory throughput for a given butterfly size. Each wing of the butterfly may be read and written at different memory banks and addresses, using conflict-free bank assignment.

For a FFT operation of data sampled at N points, where N=r·Rⁿ⁻¹, 2r≦R, R is divisible by r, and R, r are radixes of butterflies in the FFT, the FFT calculation may use a radix-R butterfly operation to calculate multiple radix-r butterflies simultaneously.

The FFT operation may result in input data and output data having different digit orders. A digit reverse operation may be performed near the beginning or the end of the FFT operation. Self-sorting may eliminate the need for separate a digit reverse operation in the FFT, and may increase the speed of the FFT.

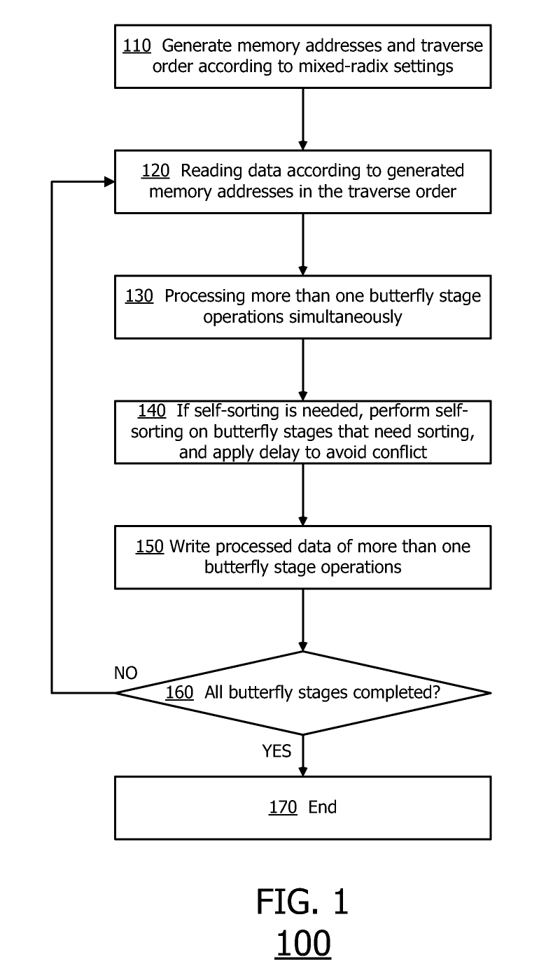

FIG. 1 illustrates an exemplary method 100 of processing data according to an embodiment of the present disclosure.

The method 100 begins at block 110, by generating memory addresses and traversal order for data according to mixed-radix settings. The method proceeds to block 120, reading the data from the memory according to the generated memory addresses in the traversal order. The method proceeds to block 130, processing the data of more than one butterfly stage operations of the FFT. The method proceeds to block 140, if self-sorting is needed, performing self-sorting on butterfly stages that need sorting, and apply any delays needed to avoid memory conflict. The method proceeds to block 150, writing the processed data of more than one butterfly stage operations into memory. The method proceeds to block 160, determining if all butterfly stages completed processing. If yes, the method ends at block 170. If no, the method returns to block 120 to read additional data as needed for additional butterfly stage operations.

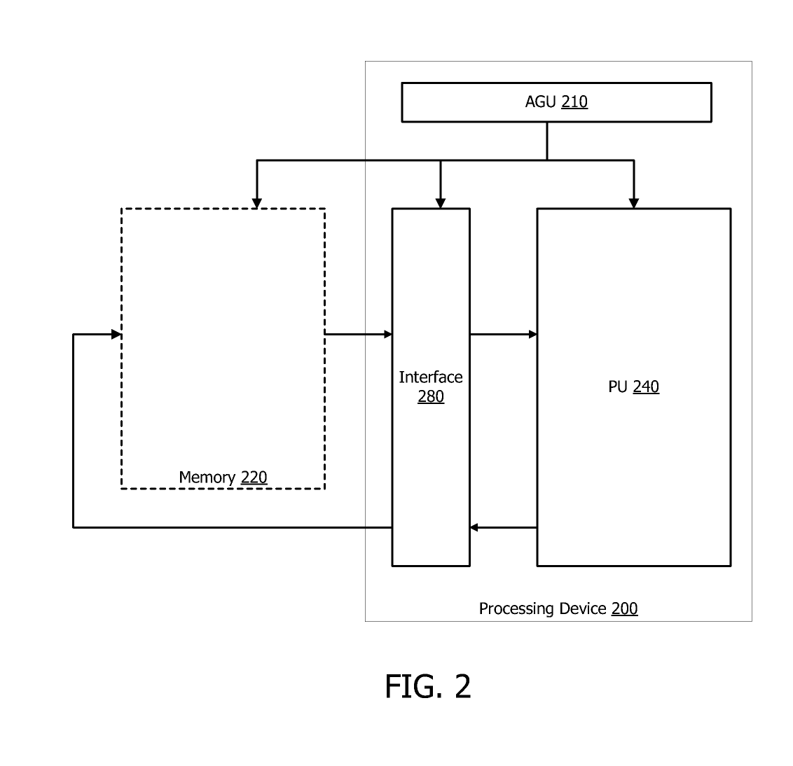

FIG. 2 illustrates an exemplary processing device 200 according to an embodiment of the present disclosure.

According to an embodiment of the present disclosure, a processing device 200 is described.

The processing device 200 may be connected to a memory 220 storing N entries of complex data points for processing. The processing device 200 may include an address generator unit (AGU) 210 that generates the memory address assignments and a traverse order for the data according to the mixed-radix settings. The AGU 210 is connected to an interface 280, which reads the data from the memory 220 according to the memory address assignments in the traversal order generated by the AGU 210 and writes the processed data back into the memory 220. The AGU 210 is connected to a processor (PU) 240, which processes the data of more than one butterfly stage operations of the FFT, prior to the interface 280 writing the processed data back to the memory 220.

For a FFT operation of data sampled at N points, where N=r₀·r₁·r₂· . . . ·rₙ₋₁, where the FFT operation decomposed into radix r₀, . . . , rₙ₋₁ stages, where rᵢ≦rᵢ₊₁, mixed-radix index numbers may be represented as follows:

[d]_{i,i+j}=dᵢ,dᵢ₊₁, . . . ,dᵢ₊ⱼ,[d]_{i+j,i}=dᵢ₊ⱼ,dᵢ₊ⱼ₋₁, . . . ,dᵢ.

If d₀, . . . , dₛ are respectively, r₀, . . . , rₛ radix digits, then [dₛ, . . . , d₀] may be a mixed-radix index number derived by concatenating the digits. If any dᵢ is a radix-1 digit, then [dₛ, . . . , dᵢ₊₁, dᵢ, dᵢ₋₁, . . . , d₀]=[dₛ, . . . , dᵢ₊₁, . . . dᵢ₋₁, . . . , d₀]

[dₛ, . . . , d₀] may also be represented as, [dₛ, . . . , d₀]=d₀+d₁·r₀+d₂·r₀·r₁+ . . . +dₛ·r₀·r₁·r₂· . . . ·rₛ₋₁.

A FFT operation may be implemented as two nested loops, with an outer loop iterating over stages c, and an inner loop iterating over butterflies (or butterfly groups for stages) with multiple butterflies executing simultaneously within one stage.

FFT(kₙ₋₁, . . . , k₀) may represent the result of a FFT operation on input indexed [kₙ₋₁, . . . , k₀] (kᵢε0 . . . rᵢ , k₀ being the least significant digit).

A radix-r butterfly operation may be represented as,

$${B}_{s} ( {f}_{r - 1} , … , {f}_{0} ) = {\sum }_{k = 0}^{r - 1} {f}_{k} \cdot {( {W}_{r} )}^{s - k}$$

where

$${W}_{r} = {e}^{- \frac{2 π i}{r}}$$

may be complex roots of one.

F_{c+1} ([d]_{c,n-c-2}, k_{c}, [k]_{c-1,n}) may represent stage c output of [[d]_{c,n-c-2}, k_{c}, [k]_{c-1,0}], where kᵢ may represent already processed digits and dᵢ are digits that are yet to be processed, where kᵢ<rᵢ, dᵢ<rₙ₋ᵢ₋₁, F₀(d₀, . . . , dₙ₋₁) are input sampled data points. Then FFT(kₙ₋₁, . . . , k₀)=Fₙ(kₙ₋₁, . . . , k₀).

For DIT decomposition, the FFT stage formula may be represented as:

F_{c+1}([d]_{0,n-c-2},k_{c},[k]_{c-1,0})=Bₖ_{₀}(w₀, . . . ,wᵣ_{_{n−c−1}}₋₁),

where wᵤ=Wᵣ_{_{n−1}}_{. . . r}_{_{n−c−1}}·F_{c}([d]_{0,n-c-2}, u, [k]_{c-1,0}).

For DIF decomposition, the FFT stage formula may be represented as:

F_{c+1}([d]_{0,n-c-2},k_{c},[k]_{c-1,0})=Wᵣ_{₀}_{, . . . ,r}_{_{n−c−1}}^{k}^{_{c}}^{·[[d]}^{_{0,n−c−2]}},Bₖ_{_{c}}( w̅₀, . . . , w̅ᵣ_{_{n−c−1}}),
where w̅ᵤ=F_{c}([d]_{0,n-c-2}, u, [k]_{c-1,0}).

DIT decompositions may lead to digit reverse order of the input data points, and DIF decomposition may lead to digit reverse order of the output data points.

DIF and DIT may differ above in whether multiplication by twiddle factors is performed before or after the butterfly operation.

For the above mentioned DIF, a radix-r_{c} butterfly in stage c utilizes inputs of the index number [kₙ₋₁, . . . , k_{c+1}, k_{c}, k_{c-1}, . . . , k₀], where k_{c} varies from 0 to r^{c}−1. Then the radix-r_{c} butterfly in stage c may be represented as [kₙ₋₁, . . . , k_{c+1}, k_{c-1}, . . . , k₀].

According to an embodiment of the present disclosure, memory 220 may be a random access memory (RAM).

According to an embodiment of the present disclosure, memory 220 may be a multi-bank memory with rₙ₋₁ banks to allow pipelining butterfly execution. A memory having multiple memory banks may have independent I/O ports and buses for each memory bank, such that multiple memory banks may be accessed (for example, in read and write operations) concurrently. Alternatively, each of the multiple memory banks may be a group of memory locations, and memory 220 may allow generally simultaneous access of multiple memory banks, by encoding, aggregating, staggering, or interleaving accesses on shared memory I/O ports and buses.

According to an embodiment of the present disclosure, PU 240 may include a processor with general processing capabilities, or specialized hardware. PU 240 may process the data sequentially, in parallel, staggered, interleaved, or in various process to prioritize between multiple butterfly stage operations, to maximize data throughput and minimize a waiting period for the memory or the processor, without having to increase overall circuit or power or clocking speed.

The memory banks in the embodiments of the present disclosure may include any of the above and other possible grouping of memory locations. Memory bank assignments in the embodiments of the present disclosure may include any memory group identification, indexes, addresses, or labels, that may be used for controlling access to a group of memory locations.

Each radix-r butterfly operation may include r memory reads and r memory writes. Memory bank and address assignments may be generated depending on the number of sampled data points, and adjusted in run-time.

For example, m(kₙ₋₁, . . . kₐ) may represent bank assignment and a(kₙ₋₁, . . . , k₀) may represent address assignment within the bank for butterfly index number [kₙ₋₁, . . . , k₀].

If for example, a(kₙ₋₁, . . . , k₀)=[kₙ₋₂, . . . , k₀], and

I_{c}([dₙ₋₁, . . . ,d_{c+1},d_{c-1}, . . . ,d₀],d)=[dₙ₋₁, . . . ,d_{c+1},d,d_{c-1}, . . . ,d₀].

then, m(kₙ₋₁, . . . , k₁, k₀)=m(I_{c}([kₙ₋₁, . . . , k_{c+1}, k_{c-1}k₁], k₀)).

While there may be a dependency between subsequent stages, butterflies within each one stage are independent from each other and therefore may be calculated in arbitrary order.

Suppose q_{c} butterflies are run simultaneously in stage c. Stage n−1 obviously has only one butterfly run simultaneously, because only rₙ₋₁ memory banks are available. For any stage c that runs q_{c} butterflies generally simultaneously, the inner loop may iterate over butterfly groups indexed [kₙ₋₁, . . . k_{c+2}, k̅_̅{̅c̅+̅1̅}̅, k_{c-1}, . . . , k₀] where

$${k}_{i} < {r}_{i} , \overline{{k}_{c + 1}} < ⌈ \frac{{r}_{c + 1}}{{q}_{c}} ⌉ .$$

T_{c}(kₙ₋₁, . . . , k_{c+2}, k̅_̅{̅c̅+̅1̅}̅, k̅_̅{̅c̅+̅1̅}̅, k_{c-1}, . . . , k₀), may represent the k̅_̅{̅c̅+̅1̅}̅'th butterfly executed in [kₙ₋₁, . . . , k_{c+2}, k̅_̅{̅c̅+̅1̅}̅, k_{c-1}, . . . , k₀]'th iteration of loop iterating over butterfly groups in stage c, where

$${k}_{i} < {r}_{i} , \overline{{k}_{c + 1}} < ⌈ \frac{{r}_{c + 1}}{{q}_{c}} ⌉ \cdot \overline{\overline{{k}_{c + 1}}} < {q}_{c} \cdot [ \overline{{k}_{c + 1}} \cdot \overline{\overline{{k}_{c + 1}}} ] < {r}_{c + 1} .$$

k_{c+1}, may be represented as being split into [ k̅_̅{̅c̅+̅1̅}̅, k̅_̅{̅c̅+̅1̅}̅], and k̅_̅{̅c̅+̅1̅}̅ is used as a part of butterfly group index number, while k̅_̅{̅c̅+̅1̅}̅ is used to enumerate butterflies within the group.

The traverse order (the sequence order of the N data sample entries in the memory to process) for all stages may be represented as:

T_{c}(kₙ₋₁, . . . ,k_{c+2}, k̅_̅{̅c̅+̅1̅}̅, k̅_̅{̅c̅+̅1̅}̅,k_{c-1}, . . . ,k₀)=[kₙ₋₁, . . . ,k_{c+2}, k̅_̅{̅c̅+̅1̅}̅, k̅_̅{̅c̅+̅1̅}̅,k_{c-1}, . . . ,k₀].

M_{c}([kₙ₋₁, . . . , k₀]) may represent the memory bank assignment for use in iteration k of butterfly loop in stage c.

q radix-r butterflies may run in parallel, using the multiple memory banks, M_{c} may be represented as:

M_{c}([kₙ₋₁, . . . ,k₀])=m(I_{c}(T_{c}(k_{n-1, . . . ,}k_{c+2}, k̅_̅{̅c̅+̅1̅}̅, k̅_̅{̅c̅+̅1̅}̅,k_{c-1}, . . . ,k₀),k_{c})).

A conflict-free bank assignment that allows multiple butterflies of small radix stages generally simultaneously in a mixed-radix FFT operation with traverse order may be represented as:

$$m ( {k}_{n - 1} , … , {k}_{0} ) = ( {\sum }_{i = 0}^{n - 1} {g}_{i} \cdot {k}_{i} ) mod {r}_{n - 1} ,$$

where gᵢ may represent constants that depend on radixes chosen for the stages of the FFT operation.

Various modifications to the above presented continuous-flow conflict-free mixed-radix FFT operation in multi-bank memory are possible.

### FFT in DSP Utilizing a Dual-Port Memory

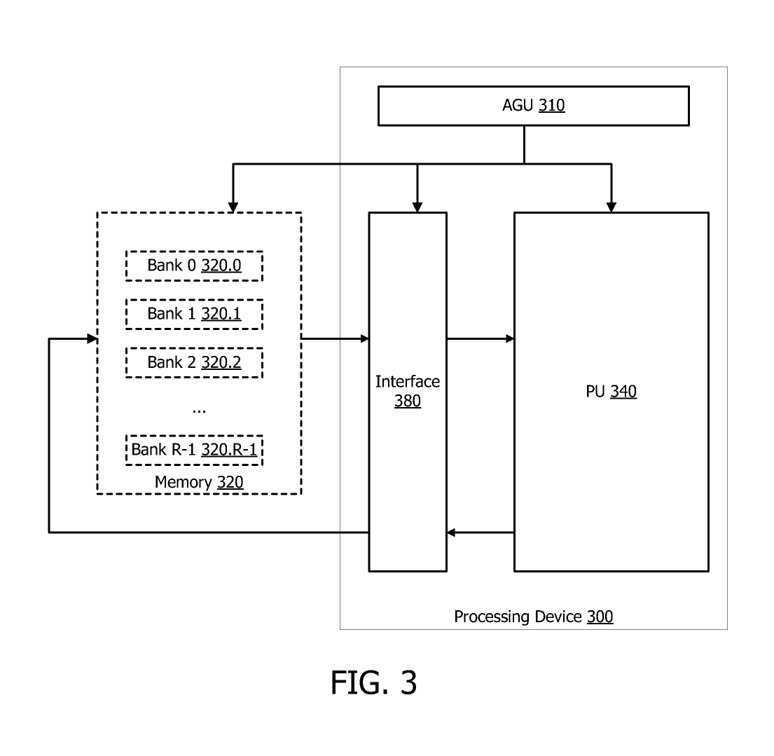

FIG. 3 illustrates an exemplary processing device 300 according to an embodiment of the present disclosure.

According to an embodiment of the present disclosure, a processing device 300 that performs a mixed-radix FFT using a dual-port multi-bank memory is described.

The processing device 300 may be connected to a memory 320 with (R number of) multiple memory banks 320.0 to 320.R−1, containing memory capacity for storing N entries of complex data points for processing. The processing device 300 may include an address generator (AGU) 310 that generates the memory address assignments and a traverse order for the data according to the mixed-radix settings. The AGU 310 is connected to an interface 380, which reads the data from the memory 320 according to the memory address assignments in the traversal order generated by the AGU 310 and writes the processed data back into the memory 320. The AGU 310 is connected to a processor (PU) 340, which processes the data of more than one butterfly stage operations of the FFT, prior to the interface 380 writing the processed data back to the memory 320.

Memory 320 here may be a dual-port memory, with one set of input (write) port and another set of output (read) port, which may allow memory 320 to perform one read operation and one write operation concurrently or generally simultaneously (for example, in a single clock period).

For example, in a FFT operation of data sampled at N points, where N=r·Rⁿ⁻¹, 2r≦R, R is divisible by r, and R, r are radixes of butterflies in the FFT. Furthermore, N=r₀·r₁·r₂· . . . ·rₙ₋₁, R=r·q, then, r₀=r, and r₁=r₂=r₃= . . . =rₙ₋₁=R.

The FFT operation may be performed using the processing device 300, by implementing addressing strategy that allows execution of q butterflies simultaneously in radix-r stage. Executing multiple butterflies simultaneously allows the FFT operation to access multiple memory banks generally simultaneously, and stage the parallel calculations in PU 340 generally simultaneously, to reduce waiting time associated with sequential processing of butterflies in the FFT. This makes radix-r calculation q times faster in speed performance.

The AGU 310 may use traverse order T_{c}, which may be represented as:

T_{c}(kₙ₋₁, . . . ,k_{c+2}, k̅_̅{̅c̅+̅1̅}̅, k̅_̅{̅c̅+̅1̅}̅,k_{c-1}, . . . ,k₀)=[kₙ₋₁, . . . ,k_{c+2}, k̅_̅{̅c̅+̅1̅}̅, k̅_̅{̅c̅+̅1̅}̅,k_{c-1}, . . . ,k₀],

and bank assignment, may be represented as:

$$m ( {k}_{n - 1} , … , {k}_{0} ) = ( {\sum }_{i = 0}^{n - 1} {k}_{i} + q {k}_{0} ) mod R ,$$

to provide conflict-free memory access.

For radix-R stage indexed c, conflicts may only occur between wings of one butterfly.

For example, if a conflict could occur on wings k̅_̅{̅c̅}̅, k̅_̅{̅c̅}̅, i.e.

m(kₙ₋₁, . . . , k̅_̅{̅c̅+̅1̅}̅,k_{c},k_{c-1}, . . . ,k₀)=m(kₙ₋₁, . . . ,k_{c+1}, k̅_̅{̅c̅}̅,k_{c-1}, . . . ,k₀),

then k̅_̅{̅c̅}̅≡ k̅_̅{̅c̅}̅ (mod R).

Because k̅_̅{̅c̅}̅, k̅_̅{̅c̅}̅<R, then k̅_̅{̅c̅}̅= k̅_̅{̅c̅}̅. Thus, conflicts in radix-R stages may be prevented.

In a similar manner, conflicts in radix-r stage within one butterfly may be prevented.

For another example, if two butterflies in the same butterfly group in radix-k′ stage could have a conflict, i.e.

m(kₙ₋₁, . . . ,k₂,\tilde{k}₁ ·q+ k̅₁̅, k̅₀̅)=m(kₙ₋₁, . . . ,k₂,\tilde{k}₁ ·q+ k̅₁̅, k̅₀̅),

where k̅₁̅, k̅₁̅<q,

then k̅₁̅+ k̅₀̅·q≡ k̅₁̅+ k̅₀̅·q (mod R).

Because k̅₀̅, k̅₀̅<r, then k̅₁̅= k̅₁̅, k̅₀̅= k̅₀̅. Thus, conflict may be prevented.

According to an embodiment of the present disclosure, values of n and r above, may be adjusted at run-time to use one FFT processing device to calculate transforms (and reverse transforms) of different sizes. For example, depending on the size of the data sample N, available memory banks, available memory I/O ports or I/O bandwidth, processor speed, or other factors, values of n and r may be adjusted at run-time to maximize the data throughput in the processing device, and to minimize a waiting period for the memory or the processor, without having to increase overall circuit or power or clocking speed.

According to an embodiment of the present disclosure, PU 340 may include a processor with general processing capabilities, or specialized hardware. PU 340 may process the data sequentially, in parallel, staggered, interleaved, or in various process to prioritize between multiple butterfly stage operations, to maximize data throughput and minimize waiting period for the memory or the processor, without having to increase overall circuit or power or clocking speed.

Table 1 below illustrates simulated performance gain in FFT operation using the above method and processing device.

TABLE 1
Estimated clocks count performance gain

| | | |
|---|---|---|
| | One butterfly | Continuous-Flow |
| No. of Data | process | Multiple Butterfly |

| Entries | Clocks | Radix | Clocks | Radix |
|---|---|---|---|---|
| 1024-point | 896 | 2/8 | 512 | 2/8 |
| 2048-point | 1280 | 4/8 | 1024 | 4/8 |

### FFT Processor Utilizing Self-Sorting Addressing

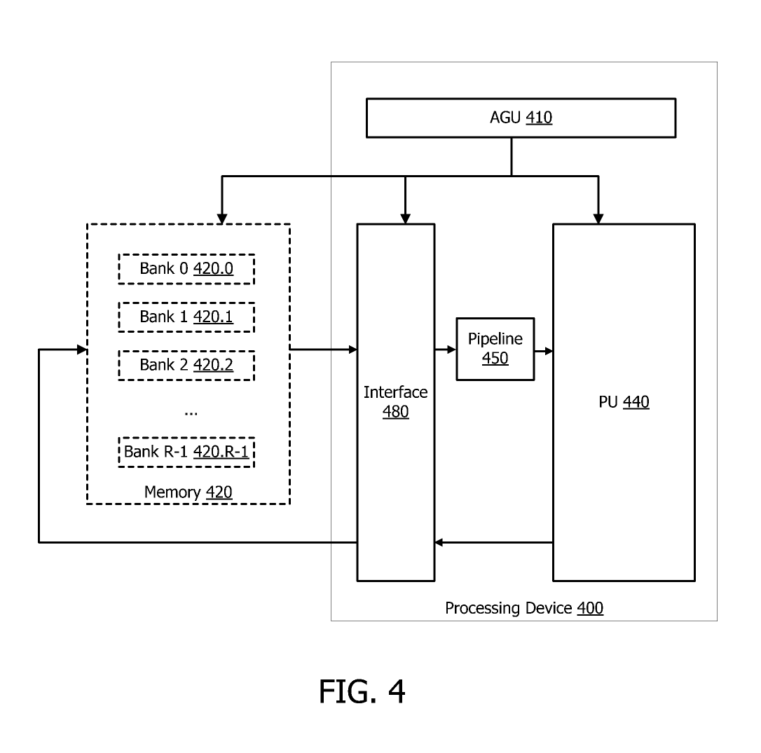

FIG. 4 illustrates an exemplary processing device 400 according to an embodiment of the present disclosure.

According to an embodiment of the present disclosure, a processing device 400 that performs a mixed-radix FFT with self-sorting using a dual-port multi-bank memory is described.

The processing device 400 may be connected to a memory 420 with (R number of) multiple memory banks 420.0 to 420.R−1, containing memory capacity for storing N entries of complex data points for processing. The processing device 400 may include an address generator (AGU) 410 that generates the memory address assignments and a traverse order for the data according to the mixed-radix settings. The AGU 410 is connected to an interface 480, which reads the data from the memory 420 according to the memory address assignments in the traversal order generated by the AGU 410 and writes the processed data back into the memory 420. The AGU 410 is connected to a processor (PU) 440, which processes the data of more than one butterfly stage operations of the FFT, prior to the interface 480 writing the processed data back to the memory 420. Additionally, a pipeline 450 connects the input interface 480 to the PU 440.

Memory 420 here may be a dual-port memory, with one set of inputs (write) port and another set of outputs (read) port, which may allow memory 420 to perform one read operation and one write operation concurrently or generally simultaneously (for example, in a single clock period).

For example, in a FFT operation of data sampled at N points, where N=r·Rⁿ⁻¹, 2r≦R, R is divisible by r, and R, r are radixes of butterflies in the FFT. Furthermore, N=r₀·r₁·r₂· . . . ·rₙ₋₁, R=r·q, then, r₀=r, and r₁=r₂=r₃= . . . =rₙ₋₁=R.

The FFT operation may be performed using the processing device 400, by implementing an addressing strategy that allows execution of q butterflies simultaneously in radix-r stage. Executing multiple butterflies simultaneously allows the FFT operation to access multiple memory banks generally simultaneously, and stage the parallel calculations in PU 440 generally simultaneously, to reduce waiting time associated with sequential processing of butterflies in the FFT. This makes radix-r calculation q times faster in speed performance.

DIT and DIF may lead to input or output data having reversed digit order. In order to obtain proper result, a digit reverse operation may need to be performed.

According to an embodiment of the present disclosure, a digit reverse operation may be incorporated into the operation of the processing device such that a separate digit reverse operation may not be required. At the same time, the processing device of the embodiment may launch multiple butterflies in radix-r stage generally simultaneously.

The AGU 410 may use bank assignment, which may be represented as:

$$m ( {k}_{n - 1} , … , {k}_{0} ) = ( {\sum }_{i = 1}^{n - 1} {k}_{i} + q {k}_{0} ) mod R ,$$

to provide conflict-free memory access.

The first

$$\frac{n + 1}{2}$$

stages may use traverse order T_{c}, which may be represented as:

T_{c}(kₙ₋₁, . . . ,k_{c+2}, k̅_̅{̅c̅+̅1̅}̅, k̅_̅{̅c̅+̅1̅}̅,k_{c-1}, . . . ,k₀)=[kₙ₋₁, . . . ,k_{c+2}, k̅_̅{̅c̅+̅1̅}̅, k̅_̅{̅c̅+̅1̅}̅,k_{c-1}, . . . ,k₀],

However, for radix-R stages, the outputs of butterflies may be transposed. The output of data indexed [ w̅, w̅] is written to memory location of data indexed [ w̅, w̅] where w̅ε0 . . . r−1, w̅ε0 . . . q.

Starting from stage

$$\frac{n + 1}{2} ,$$

for stage c, where c≠n−1, butterfly with input of data indexed

[ k̅ₙ̅₋̅₁̅, k̅ₙ̅₋̅₁̅, . . . , k̅_̅{̅c̅+̅1̅}̅, k̅_̅{̅c̅+̅1̅}̅, k̅_̅{̅c̅}̅, k̅_̅{̅c̅}̅, k̅_̅{̅c̅-̅1̅}̅, k̅_̅{̅c̅-̅1̅}̅, . . . , k̅_̅{̅n̅-̅c̅}̅, k̅_̅{̅n̅-̅c̅}̅, k̅_̅{̅n̅-̅c̅-̅1̅}̅, k̅_̅{̅n̅-̅c̅-̅1̅}̅, k̅_̅{̅n̅-̅c̅-̅2̅}̅, k̅_̅{̅n̅-̅c̅-̅2̅}̅, . . . ,k₀]

may have outputs stored in memory addresses calculated for data indexed

[ k̅ₙ̅₋̅₁̅, k̅ₙ̅₋̅₁̅, . . . , k̅_̅{̅c̅+̅1̅}̅, k̅_̅{̅c̅+̅1̅}̅, k̅_̅{̅n̅-̅c̅-̅1̅}̅, k̅_̅{̅n̅-̅c̅}̅, k̅_̅{̅c̅-̅1̅}̅, k̅_̅{̅c̅-̅1̅}̅, . . . , k̅_̅{̅n̅-̅c̅}̅, k̅_̅{̅c̅}̅, k̅_̅{̅c̅}̅, k̅_̅{̅n̅-̅c̅-̅1̅}̅, k̅_̅{̅n̅-̅c̅-̅2̅}̅, k̅_̅{̅n̅-̅c̅-̅2̅}̅, . . . ,k₀]

Alternatively, the second

$$\frac{n + 1}{2}$$

stages may use traverse order T_{c}, which may be represented as:

T_{c}(kₙ₋₁, . . . ,k_{c+2}, k̅_̅{̅c̅+̅1̅}̅, k̅_̅{̅c̅+̅1̅}̅,k_{c-1}, . . . ,k₀)=[kₙ₋₁, . . . ,k_{c+2}, k̅_̅{̅c̅+̅1̅}̅, k̅_̅{̅c̅+̅1̅}̅,k_{c-1}, . . . ,k₀],

And the first

$$\frac{n + 1}{2}$$

stages, the outputs of butterflies may be transposed.

The output transposition may be accomplished by delaying the write operations in the butterfly stages that perform the digit reverse operations above.

According to the embodiment of the present disclosure, stages performing digit reverse operations are not in-place. Thus, it may need to be ensured that during various stage computations, a memory location is written only after it is read by a butterfly.

For each stage c performing digit reverse operations, the correct order of read and write operations may be guaranteed by reordering butterflies within the stage, so that all butterflies with overlapping data index values of kₙ₋₁, . . . , k_{c+1}, k_{c-1}, . . . , k̅_̅{̅n̅-̅c̅}̅, k̅_̅{̅n̅-̅c̅-̅1̅}̅, k_{n-c-2}, . . . , k₀ are executed sequentially in one batch, and adding pipeline 450 with delays to postpone write operations for R−p clocks, where p is pipeline delay length. Since write operations of butterflies from one batch can only change data values already read in the same batch and the butterfly loop is pipelined, the correct read and write order may be ensured.

While some of the butterfly stage operations may need to have write operations delayed, parallel execution of multiple butterfly stage operations may increase the overall FFT operation speed.

According to an embodiment of the present disclosure, pipeline 450 may include any hardware and/or software component to postpone write operations for a predetermined number of clock periods. For example, pipeline 450 may include software loop delays, or hardware components, such as flip-flops, buffers, etc., capable of postponing transfer of data. Pipeline 450 may also be located anywhere along the read or write paths between memory 420, interface 480, and PU 440.

According to an embodiment of the present disclosure, values of and above, may be adjusted at run-time to use one FFT processing device to calculate transforms (and reverse transforms) of different sizes. For example, depending on the size of the data sample N, available memory banks, available memory I/O ports or I/O bandwidth, processor speed, or other factors, values of and r may be adjusted at run-time to maximize the data throughput in the processing device, and to minimize waiting period for the memory or the processor, without having to increase overall circuit or power or clocking speed.

According to an embodiment of the present disclosure, PU 440 may include a processor with general processing capabilities, or specialized hardware. PU 440 may process the data sequentially, in parallel, staggered, interleaved, or in various processes to prioritize between multiple butterfly stage operations, to maximize data throughput and minimize waiting period for the memory or the processor, without having to increase overall circuit or power or clocking speed.

### FFT Processor Utilizing Single-Port Memories

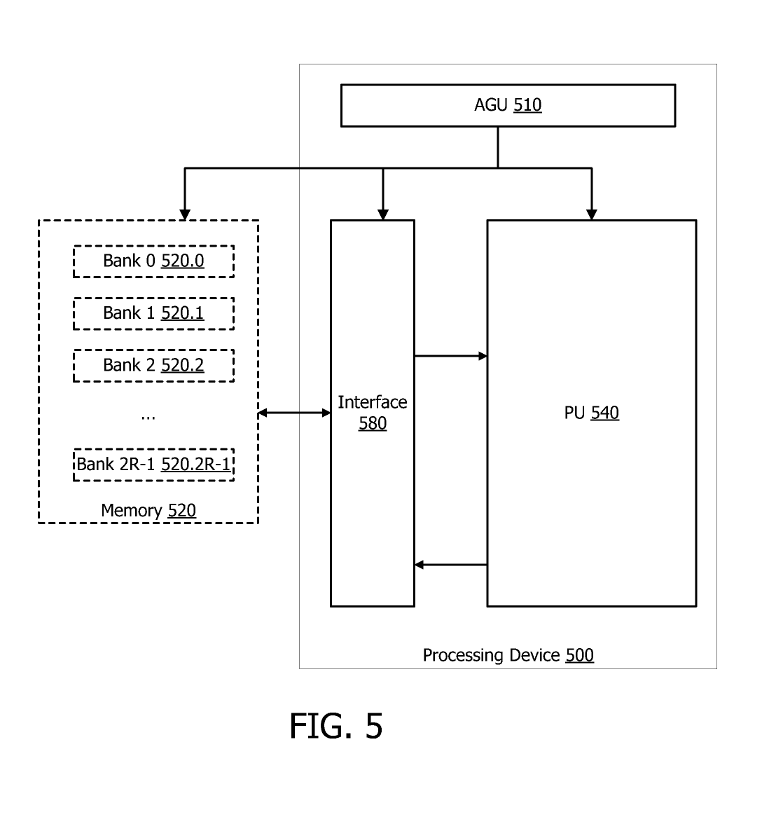

FIG. 5 illustrates an exemplary processing device 500 according to an embodiment of the present disclosure.

According to an embodiment of the present disclosure, a processing device 500 that performs a mixed-radix FFT using a single-port multi-bank memory is described.

The processing device 500 may be connected to a memory 520 with (2R number of) multiple memory banks 520.0 to 520.2R−1, containing memory capacity for storing N entries of complex data points for processing. The processing device 500 may include an address generator unit (AGU) 510 that generates the memory address assignments and a traverse order for the data according to the mixed-radix settings. The AGU 510 is connected to an interface 580, which reads the data from the memory 520 according to the memory address assignments in the traversal order generated by the AGU 510 and writes the processed data back into the memory 520. The AGU 510 is connected to a processor (PU) 540, which processes the data of more than one butterfly stage operations of the FFT, prior to the interface 580 writing the processed data back to the memory 520.

Memory 520 here may be a single-port memory, with one set of ports for both input (write) and output (read) operations. Single-port memory may require less circuitry space.

For example, in a FFT operation of data sampled at N points, where N=r·Rⁿ⁻¹, 2r≦R, R is divisible by r, and R, r are radixes of butterflies in the FFT. Furthermore, N=r₀·r₁·r₂· . . . ·rₙ₋₁, R=r·q, r is even, then, r₀=r, and r₁=r₂=r₃= . . . =rₙ₋₁=R.

The FFT operation may be performed using the processing device 500, by implementing addressing strategy that allows execution of multiple butterflies simultaneously in radix-r stage. Executing multiple butterflies simultaneously allows the FFT operation to access multiple memory banks generally simultaneously, and stage the parallel calculations in PU 540 generally simultaneously, to reduce waiting time associated with sequential processing of butterflies in the FFT.

The AGU 510 may be modified in order to allow use of 2R number of single-port memory banks without increase of overall memory words count.

The AGU 510 may generate memory bank assignments, represented as:

$$m ( {k}_{n - 1} , … , {k}_{0} ) = ( 2 {\sum }_{i = 0}^{n - 1} {k}_{i} - ( {k}_{0} mod 2 ) ) mod 2 R ,$$

and traverse order for stage 0, represented as:

$${T}_{0} ( {k}_{n - 1} , … , {k}_{2} , \overline{{k}_{1}} , \overline{\overline{{k}_{1}}} ) = [ {k}_{n - 1} , … , {k}_{2} , ( {\sum }_{i = 2}^{n - 1} {k}_{i} + \overline{{k}_{1}} + \overline{\overline{{k}_{1}}} \cdot r ) mod R ] ,$$

traverse order for other stages, represented as:

T_{c}(kₙ₋₁, . . . ,k_{c+2}, k̅_̅{̅c̅+̅1̅}̅, k̅_̅{̅c̅+̅1̅}̅,k_{c-1}, . . . ,k₀)=[kₙ₋₁, . . . ,k_{c+2}, k̅_̅{̅c̅+̅1̅}̅, k̅_̅{̅c̅+̅1̅}̅,k_{c-1}, . . . ,k₀],

If the total read and write path length between memory 520, interface 580, and PU 540 is odd (as measured in clock periods), the bank assignment m above used with traversal orders above may ensure no memory access conflicts for FFT operations in the above configuration using a single-port memory.

Because every butterfly stage operations of radix-r stage may utilize all values of k₀, and absence of conflicts in radix-R stage may be ensured by interleaving d₀ mod 2 values for subsequent butterflies, the processing device may need to wait for the radix-r stage operations to complete before launching the first radix-R stage.

For example, if radix-R stage indexed c memory conflicts might occur between read operations of different wings of one butterfly, write operations of different wings of one butterfly, or write operation of a butterfly and read operation of some subsequent butterfly, then read/write conflicts within one butterfly on wings k̅_̅{̅c̅}̅, k̅_̅{̅c̅}̅ may be represented as:

$$2 {\sum }_{i = 0 , i \neq 0}^{n - 1} {k}_{i} + 2 \overline{{k}_{0}} - ( {k}_{0} mod 2 ) ≡ 2 {\sum }_{i = 0 , i \neq 0}^{n - 1} {k}_{i} + 2 \overline{\overline{{k}_{0}}} - ( {k}_{0} mod 2 ) ( mod 2 R ) ,$$

and k̅_̅{̅c̅}̅≡ k̅_̅{̅c̅}̅ (mod R), i.e. k̅_̅{̅c̅}̅= k̅_̅{̅c̅}̅.
Thus, conflicts within one radix-R butterfly are prevented.

Since traverse order is used in radix-R stages and r is odd, values of k₀ interleave for subsequent butterfly stage operations. With the total read and write path length having odd length (as measured in clock periods), the processing device may ensure that any two butterflies that have read and write operations within the same clock would have different parity of k₀, and therefore use banks with different parity. Therefore, conflicts between wings of different butterflies in radix-R stages may be prevented. Similarly, conflicts between the butterflies of different radix-R stages may be prevented.

For radix-r stages, memory bank assignment for an arbitrary wing of arbitrary butterfly may be represented as:

$$m ( {T}_{0} ( {k}_{n - 1} , … , {k}_{2} , \overline{{k}_{1}} , \overline{\overline{{k}_{1}}} ) , {k}_{0} ) = ( 4 {\sum }_{i = 2}^{n - 1} {k}_{i} + 2 \overline{{k}_{1}} + 2 \overline{\overline{{k}_{1}}} \cdot r + 2 {k}_{0} - {k}_{0} mod 2 ) mod 2 R = ( 4 ( {\sum }_{i = 2}^{n - 1} {k}_{i} + ⌊ \frac{{k}_{0}}{2} ⌋ + \overline{\overline{{k}_{1}}} \cdot \frac{r}{2} + ⌊ \frac{\overline{{k}_{1}}}{2} ⌋ ) + 2 ( \overline{{k}_{1}} mod 2 ) + {k}_{0} mod 2 ) mod 2 R .$$

Data points in butterfly operation stages from one group may have overlapping index values of kₙ₋₁, . . . , k₂, k̅₁̅, and may differ in k̅₁̅, k₀.

Because

$$\overline{\overline{{k}_{1}}} \leq q - 1 , ⌊ \frac{{k}_{0}}{2} ⌋ \leq \frac{r}{2} - 1 ,$$

then

$${m}_{0} = 4 ⌊ \frac{{k}_{0}}{2} ⌋ + 2 r \cdot \overline{\overline{{k}_{1}}} + {k}_{0} mod 2.$$

Because

$$4 ⌊ \frac{{k}_{0}}{2} ⌋ < 2 r ,$$

index values of m₀ may overlap for overlapping index values of k̅₁̅, k₀. Thus, conflicts within one butterfly group may be prevented.

Index values of k̅₁̅ interleave for subsequent butterfly groups. With a pipeline having odd length, it guarantees that any 2 butterfly groups that have read and write operations within the same clock have different parity of k̅₁̅, therefore use banks with a different second bit in radix-2 representation of the bank's number. Hence there are no conflicts on wings of butterflies from different butterfly groups in radix-r stage.

According to an embodiment of the present disclosure, values of n and r above, may be adjusted at run-time to use one FFT processing device to calculate transforms (and reverse transforms) of different sizes. For example, depending on the size of the data sample N, available memory banks, available memory I/O ports or I/O bandwidth, processor speed, or other factors, values of n and r may be adjusted at run-time to maximize the data throughput in the processing device, and to minimize the waiting period for the memory or the processor, without having to increase overall circuit or power or clocking speed.

According to an embodiment of the present disclosure, PU 540 may include a processor with general processing capabilities, or specialized hardware. PU 540 may process the data sequentially, in parallel, staggered, interleaved, or in various process to prioritize between multiple butterfly stage operations, to maximize data throughput and minimize waiting period for the memory or the processor, without having to increase overall circuit or power or clocking speed.

Self-Sorting FFT Processor with Single-Port Memories

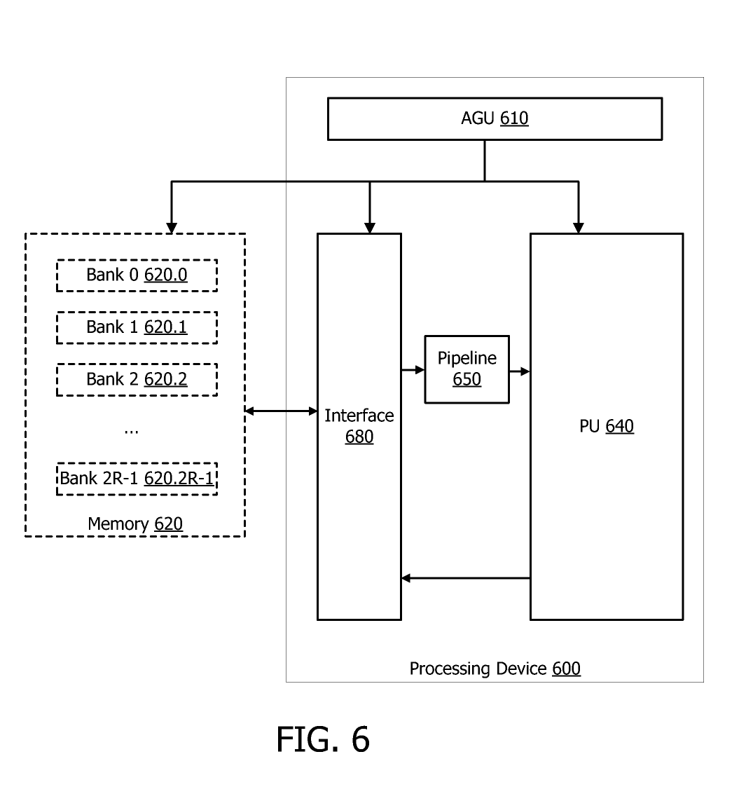

FIG. 6 illustrates an exemplary processing device 600 according to an embodiment of the present disclosure.

According to an embodiment of the present disclosure, a processing device 600 that performs a mixed-radix FFT with self-sorting using a single-port multi-bank memory is described.

The processing device 600 may be connected to a memory 620 with (2R number of) multiple memory banks 620.0 to 620.2R−1, containing memory capacity for storing N entries of complex data points for processing. The processing device 600 may include an address generator (AGU) 610 that generates the memory address assignments and a traverse order for the data according to the mixed-radix settings. The AGU 610 is connected to an interface 680, which reads the data from the memory 620 according to the memory address assignments in the traversal order generated by the AGU 610 and writes the processed data back into the memory 620. The AGU 610 is connected to a processor (PU) 640, which processes the data of more than one butterfly stage operations of the FFT, prior to the interface 680 writing the processed data back to the memory 620. Additionally, a pipeline 650 connects the input interface 680 to the PU 640.

Memory 620 here may be a single-port memory, with one set of port for both input (write) and output (read) operations. Single-port memory may require less circuitry space.

For example, in a FFT operation of data sampled at N points, where N=r·Rⁿ⁻¹, 2r≦R, R is divisible by r, and R, r are radixes of butterflies in the FFT. Furthermore, N=r₀·r₁·r₂· . . . ·rₙ₋₁, R=r·q, n≧3, r is even, then, r₀=r, and r₁=r₂=r₃= . . . =rₙ₋₁=R.

The FFT operation may be performed using the processing device 600, by implementing addressing strategy that allows execution of multiple butterflies simultaneously in radix-r stage. Executing multiple butterflies simultaneously allows the FFT operation to access multiple memory banks generally simultaneously, and stage the parallel calculations in PU 640 generally simultaneously, to reduce waiting time associated with sequential processing of butterflies in the FFT.

DIT and DIF may lead to input or output data having reversed digit order. In order to obtain proper result, a digit reverse operation may need to be performed.

According to an embodiment of the present disclosure, a digit reverse operation may be incorporated into the operation of the processing device such that a separate digit reverse operation may not be required. At the same time, the processing device of the embodiment may launch multiple butterflies in radix-r stage generally simultaneously.

In the last stage for radix-r, the bank assignment may need to be invariant with respect to switching of the last digit kₙ₋₁ and the first digit k₀. The AGU 610 may generate bank assignment, which may be represented as:

$$m ( {k}_{n - 1} , … , {k}_{0} ) = ( 2 ( {\sum }_{i = 1}^{n - 2} {k}_{i} + 2 ⌊ \frac{{k}_{0}}{2} ⌋ + 2 ⌊ \frac{{k}_{n - 1}}{2} ⌋ ) + ( {k}_{0} + {k}_{n - 1} ) mod 2 ) mod R .$$

The traverse orders generated by AGU 610 may be represented as:

$${T}_{0} ( {k}^{c} ) = \{ \begin{matrix}c = 0 , [ {k}_{n - 1} , … , {k}_{2} \cdot ( {\sum }_{i = 1}^{n - 1} {k}_{i} ) mod r + ⌊ \frac{{k}_{1}}{r} ⌋ + 2 \cdot ( {k}_{1} mod r ) ] \\ 0 < c < ⌊ \frac{n + 1}{2} ⌋ , [ {k}_{n - 1} , … , {k}_{1} , ( {k}_{0} + {k}_{n - 1} ) mod r ] \\ ⌊ \frac{n + 1}{2} ⌋ \leq c < n - 1 , [ {k}_{n - 1} , … , {k}_{n - c + 1} , [ {k}_{n - c} mod r , ⌊ \frac{{k}_{mrg}}{r} ⌋ ] [ {k}_{mrg} mod r , ⌊ \frac{{k}_{n - 0}}{r} ⌋ ] , \\ {k}_{n - c - 2} , … , {k}_{2} , {k}_{n - c - 1} , [ ⌊ \frac{{k}_{1}}{2 \cdot q} ⌋ , ( {k}_{0} + {k}_{n - 1} ) mod 2 ] ] \\ c = n - 1 , [ {k}_{n - 2} , … , {k}_{2} , \\ ( {\sum }_{i = 2}^{n - 2} {k}_{i} + [ [ \frac{{k}_{1}}{2 q} , {k}_{0} mod 2 ] , [ \frac{{k}_{1} mod q}{2} , ( {k}_{0} + \frac{{k}_{1}}{q} ) mod 2 ] ] ) mod r , [ {k}_{1} mod 2 q , ⌊ \frac{{k}_{0}}{2} ⌋ ] ]\end{matrix}$$

where

$${k}^{c} = {k}_{n - 1} , … , {k}_{c + 1} , {k}_{c - 1} , … , {k}_{0}$$

$${k}_{mrg} = ( {k}_{1} mod ( 2 \cdot q ) ) \cdot \frac{r}{2} + \frac{{k}_{0}}{2} .$$

For radix-R stages, the outputs of butterflies may be transposed. The output of data indexed [ w̅, w̅] is written to memory location of data indexed [ w̅, w̅], where wε0 . . . r−1, wε0 . . . q.

Starting from stage

$$\frac{n + 1}{2} ,$$

for stage c, where c≠n−1, butterfly with input of data indexed

[ k̅ₙ̅₋̅₁̅, k̅ₙ̅₋̅₁̅, . . . , k̅_̅{̅c̅+̅1̅}̅, k̅_̅{̅c̅+̅1̅}̅, k̅_̅{̅c̅}̅, k̅_̅{̅c̅}̅, k̅_̅{̅c̅-̅1̅}̅, k̅_̅{̅c̅-̅1̅}̅, . . . , k̅_̅{̅n̅-̅c̅}̅, k̅_̅{̅n̅-̅c̅}̅, k̅_̅{̅n̅-̅c̅-̅1̅}̅, k̅_̅{̅n̅-̅c̅-̅1̅}̅, k̅_̅{̅n̅-̅c̅-̅2̅}̅, k̅_̅{̅n̅-̅c̅-̅2̅}̅, . . . ,k₀]

may have outputs stored in memory addresses calculated for data indexed

[ k̅ₙ̅₋̅₁̅, k̅ₙ̅₋̅₁̅, . . . , k̅_̅{̅c̅+̅1̅}̅, k̅_̅{̅c̅+̅1̅}̅, k̅_̅{̅n̅-̅c̅-̅1̅}̅, k̅_̅{̅n̅-̅c̅}̅, k̅_̅{̅c̅-̅1̅}̅, k̅_̅{̅c̅-̅1̅}̅, . . . , k̅_̅{̅n̅-̅c̅}̅, k̅_̅{̅c̅}̅, k̅_̅{̅c̅}̅, k̅_̅{̅n̅-̅c̅-̅1̅}̅, k̅_̅{̅n̅-̅c̅-̅2̅}̅, k̅_̅{̅n̅-̅c̅-̅2̅}̅, . . . ,k₀]

Alternatively, the first

$$\frac{n + 1}{2}$$

stages, the outputs of butterflies may be transposed.

The output transposition may be accomplished by delaying the write operations in the butterfly stages that perform the digit reverse operations above.

According to the embodiment of the present disclosure, stages performing digit reverse operations are not in-place. Thus, it may need to be ensured that during various stage computations, a memory location is written only after it is read by a butterfly.

Furthermore, butterfly stage operations may be grouped into batches of size 2R. Read/write conflicts may be prevented by interleaving in some index values kᵢ. For example, in stage c, one size 2R batch may be formed from two size R batches covering all index values of k_{c}, k_{n-c-1}, such that index values of kᵢ interleave between the two size R batches.

For example, batch 1 having R butterflies (Butterfly 1.0, Butterfly 1.1, . . . , Butterfly 1.R−2, Butterfly 1.R−1), and batch 2 having R butterflies (Butterfly 2.0, Butterfly 2.1, . . . , Butterfly 2.R−2, Butterfly 2.R−1), can be interleaved to form a size 2R batch (Butterfly 1.0, Butterfly 2.0, Butterfly 1.1, Butterfly 2.1, . . . , Butterfly 1.R−2, Butterfly 2.R−2, Butterfly 1.R−1, Butterfly 2.R−1).

Similar to the processing device 400 in FIG. 4, the use of pipeline delay of length 2R−1−p may prevent read/write conflicts in self-sorting.

While some of the butterfly stage operations may need to have write operations delayed, parallel execution of multiple butterfly stage operations may increase the overall FFT operation speed.

According to an embodiment of the present disclosure, pipeline 650 may include any hardware and/or software component to postpone write operations for a predetermined number of clock periods. For example, pipeline 650 may include software loop delays, or hardware components, such as flip-flops, buffers, etc., capable of postponing transfer of data. Pipeline 650 may also be located any where along the read or write paths between memory 620, interface 680, and PU 640.

According to an embodiment of the present disclosure, values of n and r above, may be adjusted at run-time to use one FFT processing device to calculate transforms (and reverse transforms) of different sizes. For example, depending on the size of the data sample N, available memory banks, available memory I/O ports or I/O bandwidth, processor speed, or other factors, values of n and r may be adjusted at run-time to maximize the data throughput in the processing device, and to minimize waiting period for the memory or the processor, without having to increase overall circuit or power or clocking speed.

According to an embodiment of the present disclosure, PU 640 may include a processor with general processing capabilities, or specialized hardware. PU 640 may process the data sequentially, in parallel, staggered, interleaved, or in various process to prioritize between multiple butterfly stage operations, to maximize data throughput and minimize waiting period for the memory or the processor, without having to increase overall circuit or power or clocking speed.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A method of processing data, comprising:
generating, by an address generator, a plurality of addresses and a traversal order corresponding to the data according to a plurality of mixed-radix settings;
reading, by an interface, the data from a memory to the processor according to the plurality of the addresses in the traversal order; and
processing, by a processor, the data of more than one butterfly operations of a Fast Fourier Transform (FFT), prior to the interface writing the processed data to the memory, with a throughput of one butterfly per clock.

2. The method of claim 1, wherein the FFT is radix-r/R, R=r*q, and q is greater than one.

3. The method of claim 2, wherein the memory is a dual-port memory, and the interface reads the data from and writes the processed data to the memory using two different memory ports in a single clock period.

4. The method of claim 2, wherein the memory is a single-port memory, clocked at the same frequency as the processor.

5. The method of claim 2, further comprising performing self-sorting on half of the butterfly operations.

6. The method of claim 2, wherein the processor processes the data of more than one radix-R butterfly operations, prior to the interface writing the processed data to the memory.

7. The method of claim 6, wherein the processor processes the data of R number of radix-R butterfly operations, prior to the interface writing the processed data of R number of radix-R butterfly operations to the memory.

8. The method of claim 6, wherein the processor launches processing of the data of more than one radix-r butterfly operations concurrently instead of one radix-R butterfly operation.

9. The method of claim 6, wherein the processor processes the data of more than one radix-r butterfly operations in parallel.

10. The method of claim 6, wherein the processor processes the data of more than one radix-R butterfly operations in pipeline.

11. A processing device, comprising:
an address generator to generate a plurality of addresses and a traversal order corresponding to data according to a plurality of mixed-radix settings;
a plurality of interfaces to read the data from a memory to the processor according to the plurality of the addresses in the traversal order; and
a processor to process the data of more than one butterfly operations of a Fast Fourier Transform (FFT), prior to the interfaces writing the processed data to the memory, with a throughput of one butterfly per clock.

12. The processing device of claim 11, wherein the FFT is radix-r/R, R=r*q, and q is greater than one.

13. The processing device of claim 12, wherein the memory is a dual-port memory, and the interface is to read the data from and write the processed data to the memory using two different memory ports in a single clock period.

14. The processing device of claim 12, wherein the memory is a single-port memory, clocked at the same frequency as the processor.

15. The processing device of claim 12, wherein the processing device performs self-sorting on half of the butterfly operations.

16. The processing device of claim 12, wherein the processor is to process the data of more than one radix-R butterfly operations, prior to the interface writing the processed data to the memory.

17. The processing device of claim 16, wherein the processor is to process the data of R number of radix-R butterfly operations, prior to the interface writing the processed data of R number of radix-R butterfly operations to the memory.

18. The processing device of claim 16, wherein the processor is to launch processing of the data of more than one radix-r butterfly operations concurrently instead of one radix-R butterfly operation.

19. The processing device of claim 16, wherein the processor is to process the data of more than one radix-r butterfly operations in parallel.

20. The processing device of claim 16, wherein the processor is to process the data of more than one radix-R butterfly operations in pipeline.

21. A system, comprising:
a memory;
an address generator to generate a plurality of addresses and a traversal order corresponding to data according to a plurality of mixed-radix settings;
a plurality of interfaces to read the data from the memory to the processor according to the plurality of the addresses in the traversal order; and
a processor to process the data of more than one butterfly operations of a Fast Fourier Transform (FFT), prior to the interfaces writing the processed data to the memory, with a throughput of one butterfly per clock.
